(19) United States
(12) Patent Application Publication
(10) Pub. No.: US 2026/0171844 A1
(43) Pub. Date: Jun. 18, 2026

(54) WIRELESS POWER TRANSFER SYSTEM

(71) Applicant: Infineon Technologies Austria AG, Villach (AT)

(72) Inventors: Simone FABBRO, Udine (IT); Richard KNIPPER, Regensburg (DE); Stefano SAGGINI, Udine (IT); Giulia SEGATTI, Udine (IT)

(21) Appl. No.: 19/417,914

(22) Filed: Dec. 12, 2025

(30) Foreign Application Priority Data
Dec. 13, 2024 (DE) 102024137754.2

(51) Int. Cl. H02J 50/00; H02J 50/10

(52) U.S. Cl. CPC H02J 50/005; H02J 50/10

(57) ABSTRACT

An integrated wireless power transfer device comprises a laminated substrate comprising a plurality of layers, a first circuit comprising a first transformer winding and a second transformer winding coupled in series between a first input node and a second input node, a second circuit galvanically isolated from the first circuit and comprising a third transformer winding and a fourth transformer winding coupled in series between a first output node and a second output node, and a plurality of first contact pads and a plurality of second contact pads formed on a bottom surface of the laminated substrate. The first transformer winding is formed on a first layer of the laminated substrate, the third transformer winding is formed on the first layer of the laminated substrate, the fourth transformer winding is formed vertically above the first transformer winding on a second layer of the laminated substrate, the second transformer winding is formed vertically above the third transformer winding on the second layer of the laminated substrate, the first contact pads of the plurality of first contact pads are electrically coupled to the first circuit, and the second contact pads of the plurality of second contact pads are electrically coupled to the second circuit.

### RELATED APPLICATION

This application claims priority to German Patent Application No. 102024137754.2, filed on Dec. 13, 2024, entitled “WIRELESS POWER TRANSFER SYSTEM”, which is incorporated by reference herein in its entirety.

### TECHNICAL FIELD

The instant disclosure relates in general to a wireless power transfer system.

### BACKGROUND

Wireless power transfer systems, such as wireless charging systems, offer a convenient and safe way to transfer energy from a power source to a load. In a wireless power transfer system, energy is transferred via an isolation transformer, so that no wire-bound connection between the power source and the load is required.

A wireless power transfer system may include a transmitter coil, and a first driver chip on an input side, and a receiver coil and a second driver chip on an output side of the wireless power transfer system. The transmitter coil may receive power from a power source. A load may be connected to the receiver coil. During operation of the wireless power transfer system, the input side and the output side are each connected to different electrical potentials. Galvanic isolation between components connected to different electrical potentials is crucial. Implementing appropriate measures such that the requirements concerning galvanic isolation are met can be costly and/or can significantly increase the size of a wireless power transfer system.

There is a need for a wireless power transfer system that complies with all requirements concerning galvanic isolation, that is compact and can be manufactured easily and at low costs.

### SUMMARY

An integrated wireless power transfer device includes a laminated substrate including a plurality of layers, a first circuit including a first transformer winding and a second transformer winding coupled in series between a first input node and a second input node, a second circuit galvanically isolated from the first circuit and including a third transformer winding and a fourth transformer winding coupled in series between a first output node and a second output node, and a plurality of first contact pads and a plurality of second contact pads formed on a bottom surface of the laminated substrate, wherein the first transformer winding is formed on a first layer of the laminated substrate, the third transformer winding is formed laterally spaced apart from the first transformer winding on the first layer of the laminated substrate, the fourth transformer winding is formed vertically above the first transformer winding on a second layer of the laminated substrate, the second transformer winding is formed vertically above the third transformer winding on the second layer of the laminated substrate, the first contact pads of the plurality of first contact pads are electrically coupled to the first circuit, and the second contact pads of the plurality of second contact pads are electrically coupled to the second circuit.

An electrical device includes the integrated wireless power transfer device, a first circuit arrangement including a first circuit element, wherein the first circuit arrangement is electrically coupled to one or more of the plurality of first contact pads, a second circuit arrangement including a second circuit element, wherein the second circuit arrangement is electrically coupled to one or more of the plurality of second contact pads, wherein the first circuit arrangement is galvanically isolated from the second circuit arrangement, and the integrated wireless power transfer device is configured to transmit power from the first circuit arrangement to the second circuit arrangement to operate the second circuit element.

The disclosure may be better understood with reference to the following drawings and the description. The components in the figures are not necessarily to scale, emphasis instead being placed upon illustrating the principles of the disclosure. Moreover, in the figures, like referenced numerals designate corresponding parts throughout the different views.

### BRIEF DESCRIPTION OF THE DRAWINGS

FIG. 1, in a circuit diagram, schematically illustrates elements of a conventional wireless power transfer device.

FIG. 2, in a circuit diagram, schematically illustrates elements of an integrated wireless power transfer device according to embodiments of the disclosure.

FIG. 3 schematically illustrates in a cross-sectional view transformer windings of an integrated wireless power transfer device according to embodiments of the disclosure.

FIG. 4 schematically illustrates in a cross-sectional view an integrated wireless power transfer device according to embodiments of the disclosure.

FIG. 5 schematically illustrates in a top view an integrated wireless power transfer device according to embodiments of the disclosure.

FIG. 6 schematically illustrates in another cross-sectional view an integrated wireless power transfer device according to embodiments of the disclosure.

FIG. 7 schematically illustrates in a cross-sectional view an integrated wireless power transfer device according to further embodiments of the disclosure.

FIG. 8 schematically illustrates in a top view an integrated wireless power transfer device according to further embodiments of the disclosure.

FIG. 9 schematically illustrates in another cross-sectional view an integrated wireless power transfer device according to further embodiments of the disclosure.

FIG. 10 schematically illustrates in a top view an integrated wireless power transfer device according to even further embodiments of the disclosure

FIG. 11 schematically illustrates in another cross-sectional view an integrated wireless power transfer device according to even further embodiments of the disclosure.

FIG. 12 schematically illustrates in a cross-sectional view an integrated wireless power transfer device according to embodiments of the disclosure.

FIGS. 13A-13C schematically illustrate in cross-sectional views integrated wireless power transfer devices according to further embodiments of the disclosure.

FIG. 14 schematically illustrates in a cross-sectional view an electrical device according to embodiments of the disclosure.

FIGS. 15A and 15B schematically illustrate in top views transformer windings of an integrated wireless power transfer device according to further embodiments of the disclosure.

### DETAILED DESCRIPTION

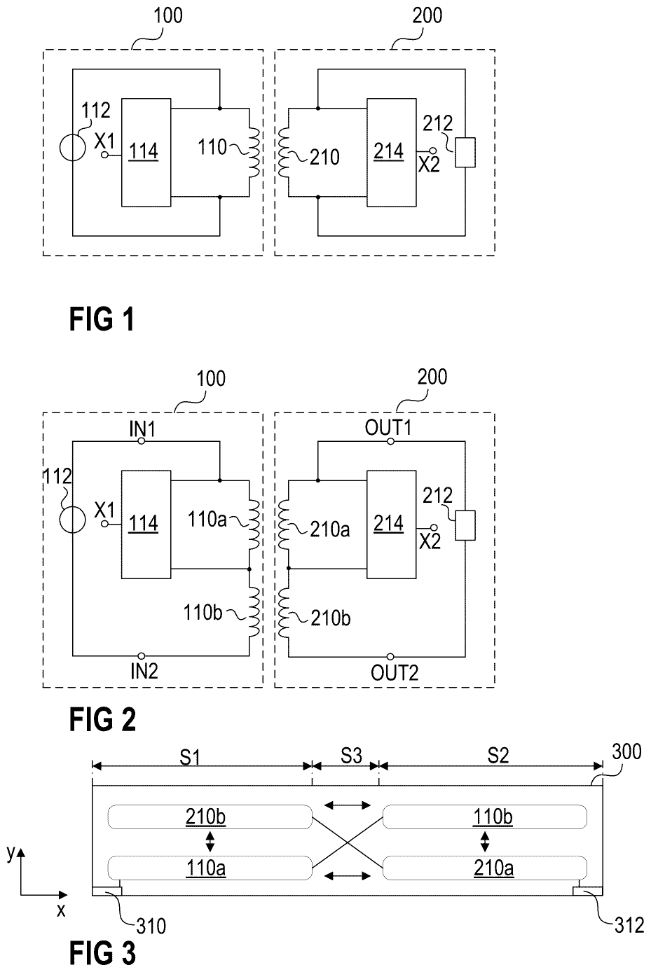

Wireless power transfer systems, such as wireless charging systems, offer a convenient and safe way to transfer energy from a power source to a load. In a wireless power transfer system, energy is transferred via an isolation transformer, so that no galvanic connection between the power source and the load is required. Referring to FIG. 1, a wireless power transfer system is schematically illustrated. The wireless power transfer system includes a first transformer coil 110, and a first control component 114 on a first side 100, and a second transformer coil 210 and a second control component 214 on a second side 200 of the wireless power transfer system. The first transformer coil 110 may receive power from a power source 112. A load 212 may be connected to the second transformer coil 210. During operation of the wireless power transfer system, the first side 100 and the second side 200 are each connected to different electrical potentials. In other words, the first circuit 100 may be configured to be operated in a first voltage domain, and the second circuit 200 may be configured to be operated in a second voltage domain different from the first voltage domain. Galvanic isolation between components connected to different electrical potentials or voltage domains is crucial. Implementing appropriate measures such that the requirements concerning galvanic isolation are met can be costly and/or can significantly increase the size of a wireless power transfer system.

Now referring to FIGS. 2 and 3, an integrated wireless power transfer device according to embodiments of the disclosure is schematically illustrated. In particular, FIG. 2, in a block diagram, schematically illustrates elements of an integrated wireless power transfer device according to embodiments of the disclosure. FIG. 3 schematically illustrates, in a cross-sectional view, a laminated substrate 300 with transformer windings of an integrated wireless power transfer device formed therein according to embodiments of the disclosure. In the integrated wireless power transfer device, the first circuit 100, instead of a single transformer coil 110, comprises a first transformer winding 110a and a second transformer winding 110b. Similarly, the second circuit 220, instead of a single transformer coil 210, comprises a third transformer winding 210a and a fourth transformer winding 210b. In particular, the integrated wireless power transfer device comprises a first circuit 100 comprising a first transformer winding 110a and a second transformer winding 110b coupled in series between a first input node IN1 and a second input node IN2, and a second circuit 200 galvanically isolated from the first circuit 100 and comprising a third transformer winding 210a and a fourth transformer winding 210b coupled in series between a first output node OUT1 and a second output node OUT2. Similar to what has been described with respect to FIG. 1 above, the first transformer winding 110a and the second transformer winding 110b may receive power from a power source 112. A load 212 may be connected to the third transformer winding 210a and the fourth transformer winding 210b.

In the wireless power transfer device exemplarily illustrated in FIG. 2, power can be transferred from the first circuit 100 to the second circuit 200. This, however, is only an example. It is generally also possible that a wireless power transfer device is bidirectional. That is, it is generally possible that, in a first mode, the wireless power transfer device is configured to transfer power from the first circuit 100 to the second circuit 200. The wireless power transfer device can be further configured to, in a second mode, transfer power from the second circuit 200 to the first circuit 100. That is, the wireless power transfer device with the components as well as the interconnections between the components as illustrated in FIG. 2 is merely one out of several possible examples. The wireless power transfer device can comprise more components than those illustrated in FIG. 2. Further, the different components can generally be connected to each other in any suitable way which allows that power be transferred from the first circuit 100 to the second circuit 200 and/or vice versa.

Referring to FIG. 3, the integrated wireless power transfer device further comprises a laminated substrate 300 comprising a plurality of layers, and a plurality of first contact pads 310 and a plurality of second contact pads 312 formed on a bottom surface of the laminated substrate 300. The first transformer winding 110a is formed on a first layer of the laminated substrate 300, the third transformer winding 210a is formed laterally spaced apart from the first transformer winding 110a on the first layer of the laminated substrate 300, the fourth transformer winding 210b is formed vertically above the first transformer winding 110a on a second layer of the laminated substrate 300, and the second transformer winding 110b is formed vertically above the third transformer winding 210a on the second layer of the laminated substrate 300. The first contact pads 310 of the plurality of first contact pads 310 are electrically coupled to the first circuit 100, and the second contact pads 312 of the plurality of second contact pads 312 are electrically coupled to the second circuit 200. The specific arrangement of the different transformer windings 110a, 110b, 210a, 210b in the laminated substrate 300 allows the integrated wireless power transfer device to be implemented in a very compact way and at comparably low costs, while fully complying with all requirements concerning galvanic isolation. This will be described in further detail below.

The first layer and the second layer of the laminated substrate 300 may be directly adjoining layers. It is, however, also possible that one or more additional layers of the laminated substrate 300 are arranged between the first layer and the second layer. Further, a surface of the first layer may form the bottom surface of the laminated substrate 300. Alternatively, one or more additional layers of the laminated substrate 300 may be arranged between the first layer and the bottom of the laminated substrate 300.

As can be seen in the cross-sectional view of FIG. 3, the first transformer winding 110a and the fourth transformer winding 210b may be arranged closer to a first lateral side of the laminated substrate 300 than to a second lateral side, opposite the first lateral side, and the third transformer winding 210a and the second transformer winding 110b may be arranged closer to the second lateral side of the laminated substrate 300 than to the first lateral side. The plurality of first contact pads 310 may be arranged partly below the first transformer winding 110a, and the second plurality of contact pads 312 may be arranged partly below the third transformer winding 210a, for example. That is, the plurality of first contact pads 310 may be arranged partly below the transformer winding they are electrically connected to. Similarly, the plurality of second contact pads 312 may be arranged partly below the transformer winding they are electrically connected to. The contact pads of the first and second plurality of contact pads 310, 312, however, do not necessarily have to be arranged partly below the respective transformer winding 110a, 210a. Some or all contact pads may be arranged laterally spaced apart from the respective transformer winding 110a, 210a. However, it can be said that the plurality of first contact pads 310 may be arranged closer to the first transformer winding 110a than to the third transformer winding 210a, and the plurality of second contact pads 312 may be arranged closer to the third transformer winding 210a than to the first transformer winding 110a. As the plurality of first contact pads 310 and the first transformer winding 110a are coupled to the same electrical potential, and similarly the plurality of second contact pads 312 and the third transformer winding 210a are coupled to the same electrical potential, the first layer as well as any (optional) additional layers of the laminated substrate 300 arranged below the first transformer winding 110a and the third transformer winding 210a (between the first and third transformer windings 110a, 210a and the bottom of the laminated substrate 300) can be implemented as comparably thin layer(s). This is, because only functional isolation is required between components coupled to the same electrical potential.

A galvanic isolation between the plurality of first contact pads 310 and the third transformer winding 210a results from a sufficiently large distance between the concerned elements in the lateral direction. This similarly applies for the plurality of second contact pads 312 and the first transformer winding 110a. Further, the plurality of first contact pads 310 are sufficiently galvanically isolated from the fourth transformer winding 210b, and the plurality of second contact pads 312 are sufficiently galvanically isolated from the second transformer winding 110b by means of the different layers of the laminated substrate 300 arranged therebetween (i.e. first and second layer of laminated substrate 300, as well as any optional further layers of the laminated substrate 300). The specific arrangement of the different components in the laminated substrate 300, in particular the diagonal arrangement of the first and second transformer winding 110a, 110b, and the third and fourth transformer winding 210a, 210b, respectively, ensures sufficient galvanic isolation between components of the first circuit 100 and components of the second circuit.

Still referring to FIG. 3, the following may apply. The laminated substrate 300 may be essentially divided in a first section S1 and a second section S2 arranged next to each other in a lateral direction. The first transformer winding 110a, the fourth transformer winding 210b, and the plurality of first contact pads 310 may be arranged in the first section S1, and the third transformer winding 210a, the second transformer winding 110b, and the plurality of second contact pads 312 may be arranged in the second section S2. A third section S3 may be arranged between the first section S1 and the second section S2, wherein no conductive structures other than simple conductor tracks that are required to electrically couple elements arranged in the first section S1 to elements arranged in the second section S2 are arranged in the third section S3. In this way, galvanic isolation may be ensured between elements arranged in the first section S1 and elements arranged in the second section S2.

As mentioned above, the first circuit 100 may be configured to wirelessly transmit power to the second circuit 200, and/or to wirelessly receive power from the second circuit 200. Accordingly, the first circuit 100 may further comprise a first control component 114, configured to control power transmission from the first circuit 100 to the second circuit 200. Alternatively or additionally, the first control component 114 may be configured to control power reception. The second circuit 200 may further comprise a second control component 214 configured to control power reception and arranged on or integrated in the laminated substrate 300. Alternatively or additionally, the second control component 214 may be configured to control power transmission from the second circuit 200 to the first circuit 100. A first control component 114 and a second control component 214 are schematically illustrated in the exemplary circuit diagram of FIG. 2.

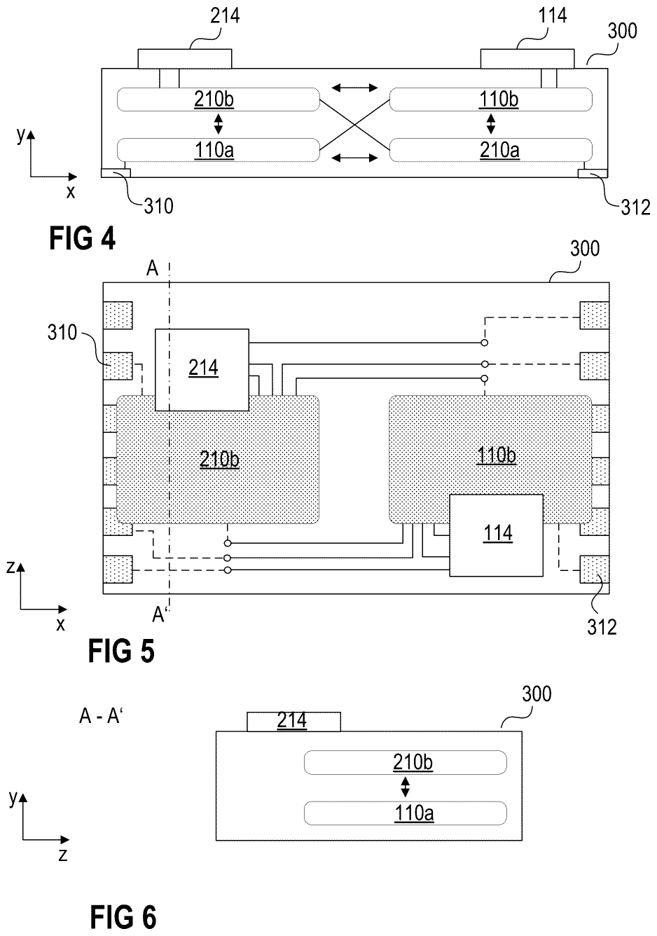

The first control component 114 and the second control component 214 may be arranged on or integrated in the laminated substrate 300. Now referring to FIG. 4, at least a third layer of the laminated substrate 300 may be arranged between the second layer with the second and fourth transformer windings 110b, 210b formed thereon and a top surface of the laminated substrate 300 opposite the bottom surface. The second control component 214 is arranged on the top surface of the laminated substrate 300, and the first control component 114 is arranged on the top surface of the laminated substrate 300. The second control component 214 in the example illustrated in FIG. 4 is arranged closer to the first lateral side of the laminated substrate 300 than to the second lateral side, and the first control component 114 is arranged closer to the second lateral side of the laminated substrate 300 than to the first lateral side. In this way, the first control component 114, which is part of the first circuit 100 is arranged closer to the second transformer winding 110b, which is also part of the first circuit 100, than to the fourth transformer winding 210b, which is part of the second circuit 200. Similarly, the second control component 214, which is part of the second circuit 200, is arranged closer to the fourth transformer winding 210b, which is also part of the second circuit 200, than to the second transformer winding 110b, which is part of the first circuit 100. In this way, sufficient galvanic isolation between the first circuit 100 and the second circuit 200 can be ensured, even if any layers of the laminated substrate 300 arranged vertically above the second layer are comparably thin.

Still referring to FIG. 4 and further referring to FIGS. 5 and 6, the second control component 214 may be at least partly arranged vertically above the fourth transformer winding 210b, and/or the first control component 114 may be at least partly arranged vertically above the second transformer winding 110b. In this way, the integrated wireless power transfer device can be implemented in a compact and space saving way, while still providing sufficient galvanic isolation between the first circuit 100 and the second circuit 200. FIG. 5 schematically illustrates in a top view an integrated wireless power transfer device in which the second control component 214 is partly arranged vertically above the fourth transformer winding 210b, and the first control component 114 is at least partly arranged vertically above the second transformer winding 110b. FIG. 6 schematically illustrates the integrated wireless power transfer device of FIG. 5 in another cross-sectional view (along section plane A-A′ as indicated in FIG. 5). The arrangements illustrated in FIGS. 4, 5 and 6, however, are only examples.

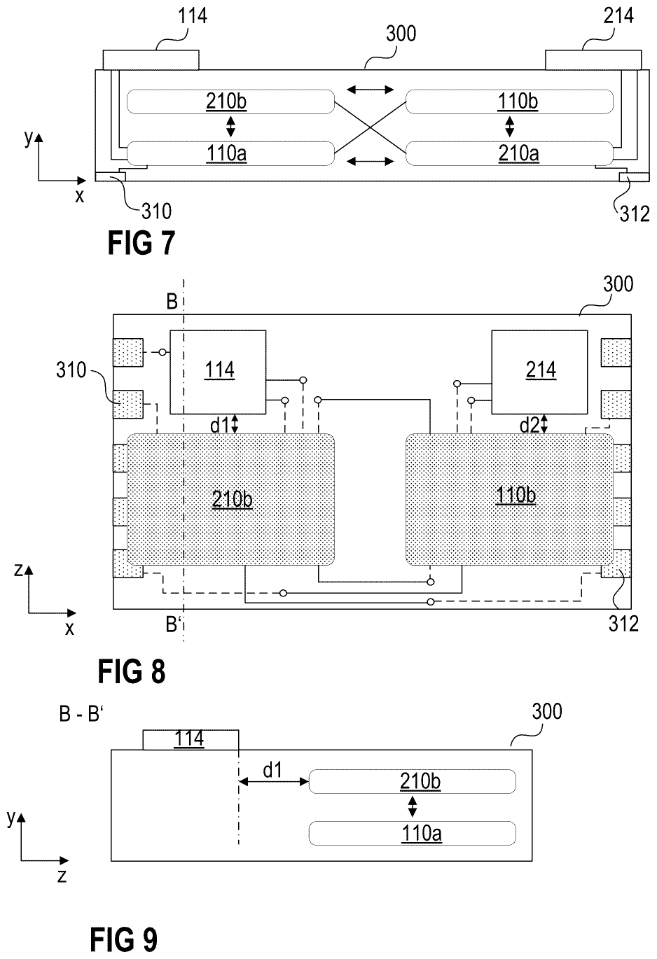

According to alternative embodiments, it is also possible that the first control component 114 is arranged closer to the first lateral side of the laminated substrate 300 than to the second lateral side, and the second control component 214 is arranged closer to the second lateral side of the laminated substrate 300 than to the first lateral side. This is schematically illustrated in FIGS. 7, 8, and 9. In this case, the first control component 114, which is part of the first circuit 100 is arranged closer to the fourth transformer winding 210b, which is part of the second circuit 200, than to the second transformer winding 110b, which is part of the first circuit 100. Similarly, the second control component 214, which is part of the second circuit 200, is arranged closer to the second transformer winding 110b, which is part of the first circuit 100, than to the fourth transformer winding 210b, which is part of the second circuit 200. Therefore, in order to ensure sufficient galvanic isolation between the first circuit 100 and the second circuit 200, the first control component 114 in this example may be laterally spaced apart from the fourth transformer winding 210b such that a lateral distance d1 between the first control component 114 and the fourth transformer winding 210b is greater than zero (see FIGS. 8 and 9). Additionally or alternatively, the second control component 214 may be laterally spaced apart from the second transformer winding 110b such that a lateral distance d2 between the second control component 214 and the second transformer winding 110b is greater than zero (see FIG. 8). The lateral distances d1, d2 may generally be set large enough to ensure dielectric isolation between the first control component 114 and the fourth transformer winding 210b, and between the second control component 214 and the second transformer winding 110b, respectively. In some cases a short lateral distance d1, d2 may suffice, while in other cases, a comparably large lateral distance d1, d2 may be required to reliably ensure dielectric isolation.

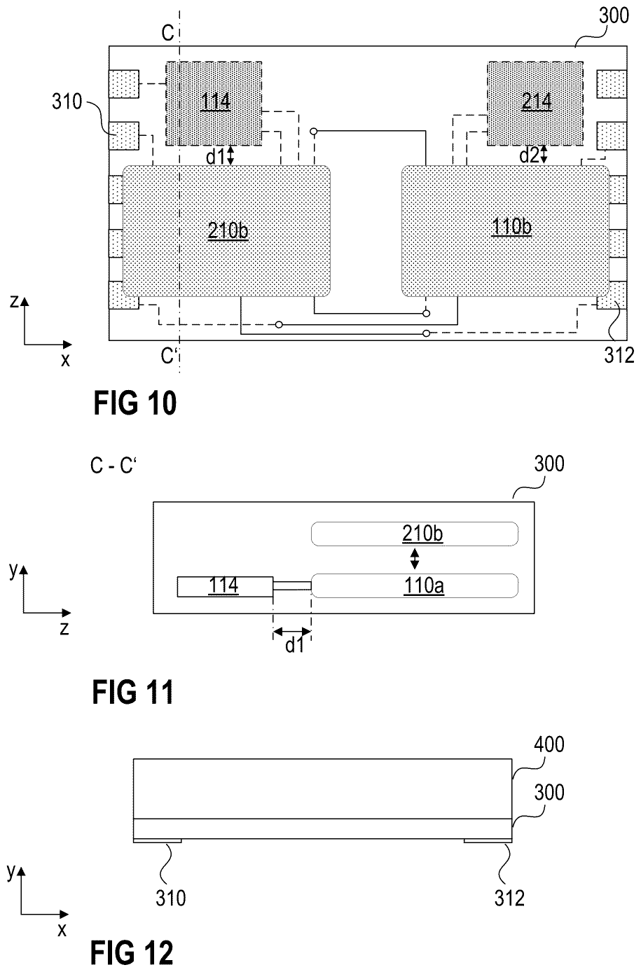

In the exemplary arrangements illustrated in FIGS. 4 to 9, the first control component 114 and the second control component 214 are both arranged on the laminated substrate 300 (i.e. on a top surface of the laminated substrate 300, opposite the bottom surface). It is, however, generally also possible that at least one of the first control component 114 and the second control component 214 be integrated in the laminated substrate 300. In the arrangement schematically illustrated in FIGS. 10 and 11, the first control component 114 and the second control component 214 are both integrated in the laminated substrate 300. For example, and as is schematically illustrated in the cross-sectional view of FIG. 11, the first control component 114 and/or the second control component 214 may be arranged on the first layer of the laminated substrate 300 (the same layer the first transformer winding 110a, and the third transformer winding 210a are formed on).

In the example illustrated in FIGS. 10 and 11, the first control component 114 is arranged closer to the first lateral side than to the second lateral side, and the second control component 214 is arranged closer to the second lateral side than to the first lateral side. In this way, the first control component 114, which is part of the first circuit 100, is arranged in the same plane as the first transformer winding 110a, and the third transformer winding 210a, and closer to the first transformer winding 110a, which is part of the first circuit 100, than to the third transformer winding 210a, which is part of the second circuit 200. The second control component 214, which is part of the second circuit 200, is also arranged in the same plane as the first transformer winding 110a, and the third transformer winding 210a, and closer to the third transformer winding 210a, which is part of the second circuit 200, than to the first transformer winding 110a, which is part of the first circuit 100. Thus, a lateral distance d1 between the first control component 114 and the first transformer winding 110a, and a lateral distance d2 between the second control component 214 and the third transformer winding 210a may be comparably small.

The electrical connections between the different elements of the integrated wireless power transfer device may be implemented by means of conductor tracks (e.g., metallic layers) on different layers of the laminated substrate 300. Conductor tracks arranged on different layers of the laminated substrate 300 may be electrically coupled to each other by means of so-called vias, for example. In FIGS. 5, 8, and 10, conductor tracks formed on the first layer of the laminated substrate 300 are indicated in dashed lines, while conductor tracks formed on the second layer of the laminated substrate 300 are indicated in solid lines. Vias between conductor tracks arranged on different layers are indicated by means of circles. In the top views of FIGS. 5, 8, and 10, only the second transformer winding 110b and the fourth transformer winding 210b arranged on the second layer of the laminated substrate 300 are visible. The first transformer winding 110a arranged on the first layer is concealed by the fourth transformer winding 210b, and the third transformer winding 210a arranged on the first layer is concealed by the second transformer winding 110b.

According to some examples, the first transformer winding 110a may be wound in a clockwise direction, and the second transformer winding 110b may be wound in a counterclockwise direction. Alternatively, the first transformer winding 110a may be wound in a counterclockwise direction, and the second transformer winding 110b may be wound in a clockwise direction. This similarly applies for the third transformer winding 210a, and the fourth transformer winding 210b. In particular, the third transformer winding 210a may be wound in a clockwise direction, and the fourth transformer winding 210b may be wound in a counterclockwise direction, or the third transformer winding 210a may be wound in a counterclockwise direction, and the fourth transformer winding 210b may be wound in a clockwise direction. If two transformer windings that belong to the same circuit 100, 200 are wound up clockwise and counterclockwise, respectively, this results in magnetic fields which, at a defined distance from the respective transformer windings, cancel each other out.

Now referring to FIG. 12, the integrated wireless power transfer device may further comprise a mold compound 400 covering a top surface of the laminated substrate 300 opposite the bottom surface. In this way, the top surface of the laminated substrate 300 and any components arranged thereon (e.g., first control component 114 and/or second control component 214) may be protected from environmental influences and mechanical damage. The integrated wireless power transfer device thus may be securely handled and integrated in an electrical device, which will be described in further detail below.

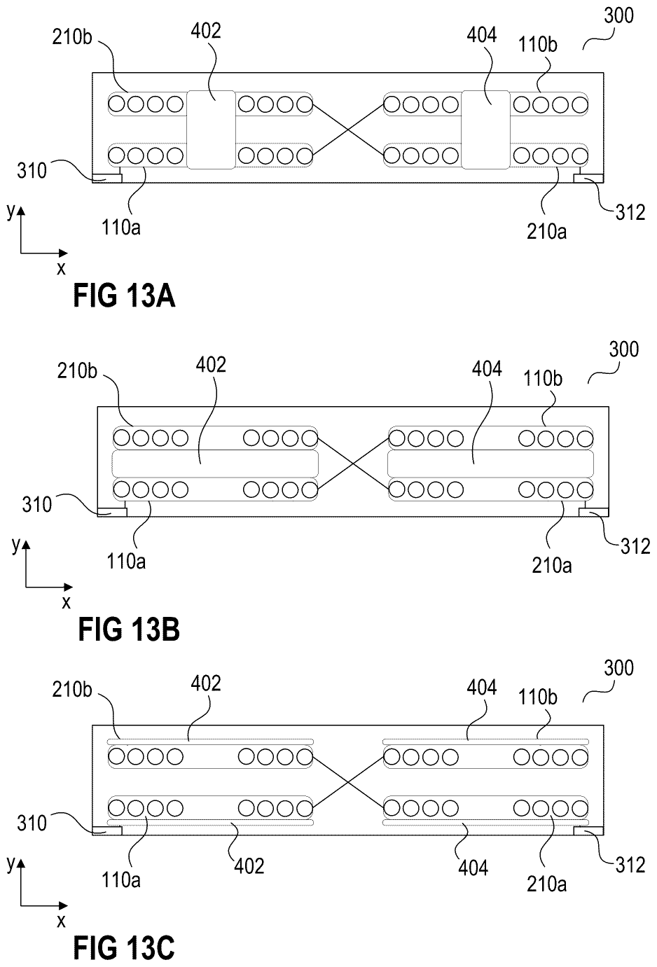

Now referring to FIG. 13A, the integrated wireless power transfer device may further comprise a first magnetic core 402 comprising one or more layers of magnetic material, and extending vertically through the laminated substrate 300 and through a central area of the fourth transformer winding 210b and a central area of the first transformer winding 110a. Alternatively or additionally, the integrated wireless power transfer device may further comprise a second magnetic core 404 comprising one or more layers of magnetic material, and extending vertically through the laminated substrate 300 and through a central area of the second transformer winding 110b and a central area of the third transformer winding 210a. The first and second magnetic core 402, 404 may be configured to guide the respective magnetic fields. The first and second magnetic core 402, 404, for example, may comprise or consist of a ferromagnetic metal such as iron, or ferrimagnetic compounds such as ferrites. The use of a magnetic core can increase the strength of the magnetic field in an electromagnetic coil by a factor of several hundred times, as compared to an implementation without the core. In FIG. 13A, the transformer windings 110a, 110b, 210a, 210b are indicated by means of circles extending around a central area and around the respective magnetic cores 402, 404 arranged in the central areas. This only very generally indicates an arrangement of the transformer windings in the laminated substrate 300. Different windings of a transformer winding may be arranged in the same plane, as schematically illustrated in FIG. 13A, as well as in different planes, for example.

Each of the first magnetic core 402 and the second magnetic core 404 may extend through all, or only through a subset of the layers of the laminated substrate 300. In the example illustrated in FIG. 13A, the first magnetic core 402 and the second magnetic core 404 only extend through a subset of the layers of the laminated substrate 300. That is, in the example illustrated in FIG. 13A, the first magnetic core 402 and the second magnetic core 404 are not visible at the top surface and the bottom surface of the laminated substrate 300. It is, however, also possible that the first magnetic core 402 and the second magnetic core 404 extend through the entire layer stack forming the laminated substrate 300 such that they are visible at the top surface and the bottom surface of the laminated substrate 300. A first and second magnetic core 402, 404 may generally be implemented in any suitable way.

Referring to FIGS. 13B and 13C, it is also possible that a magnetic core 402, 404, instead of or in addition to extending vertically through the laminated substrate 300 and through a central area of the respective transformer windings as illustrated in FIG. 13A, extends horizontally between the respective transformer windings (see FIG. 13B), above and/or below the respective transformer windings (see FIG. 13C). That is, generally speaking, an integrated wireless power transfer device may comprise a first magnetic core 402 comprising one or more layers of magnetic material arranged between the fourth transformer winding 210b and the first transformer winding 110a, one or more layers of magnetic material arranged between the first transformer winding 110a and the bottom surface of the laminated substrate 300, and/or one or more layers of magnetic material arranged between the fourth transformer winding 210b and a top surface of the laminated substrate 300 opposite the bottom surface. Similarly, the integrated wireless power transfer device may comprise a second magnetic core 404 comprising one or more layers of magnetic material arranged between the second transformer winding 110b and the third transformer winding 210a, one or more layers of magnetic material arranged between the third transformer winding 210a and the bottom surface of the laminated substrate 300 and/or one or more layers of magnetic material arranged between the second transformer winding 110b and the top surface of the laminated substrate 300.

The different embodiments illustrated in FIGS. 13A, 13B and 13C may generally be suitably combined with each other. In FIGS. 13B and 13C, the first magnetic core 402 is illustrated having dimensions in the horizontal direction x which essentially equal the dimensions of the respective transformer windings 110a, 210b in the same direction. Similarly, the second magnetic core 404 is illustrated having dimensions in the horizontal direction x which essentially equal the dimensions of the respective transformer windings 110b, 210a. This, however, is only an example. The magnetic cores 402, 404 in the horizontal direction x may generally have dimensions which differ from the dimensions of the respective transformer windings in the same direction. The magnetic material forming the first magnetic core 402 and the second magnetic core 404 may be applied to or formed in one or more layers of the laminated substrate 300. By suitably choosing the general shape and size of a magnetic core 402, 404, the field distribution may be set or influenced in a desired way.

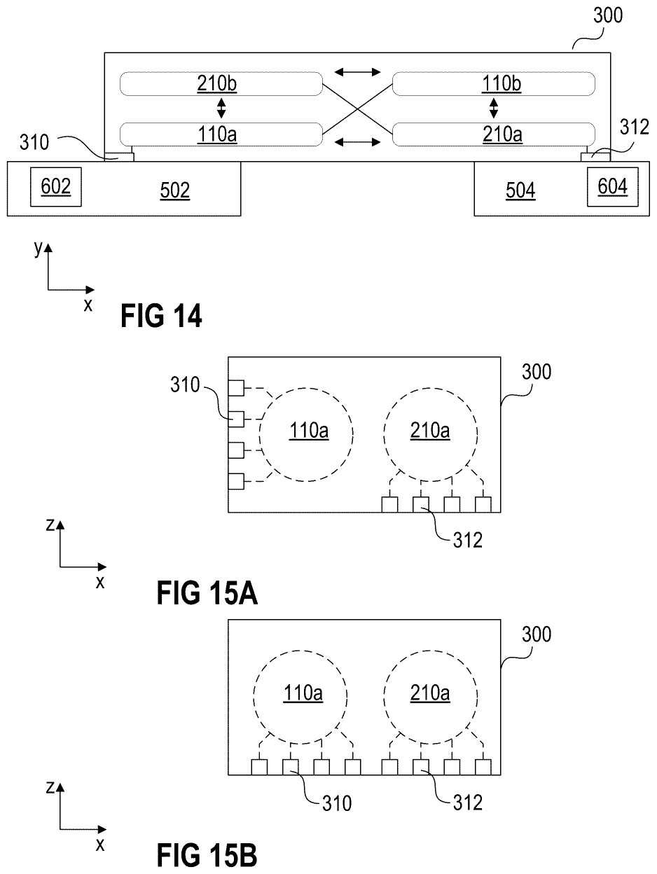

Now referring to FIG. 14, an electrical device according to embodiments of the disclosure is schematically illustrated. The electrical device comprises an integrated wireless power transfer device according to any of the different embodiments described herein. The electrical device further comprises a first circuit arrangement 502 including a first circuit element 602, wherein the first circuit arrangement 502 is electrically coupled to one or more of the plurality of first contact pads 310, and a second circuit arrangement 504 including a second circuit element 604, wherein the second circuit arrangement 504 is electrically coupled to one or more of the plurality of second contact pads 312. The first circuit arrangement 502 is galvanically isolated from the second circuit arrangement 504, and the integrated wireless power transfer device is configured to transmit power from the first circuit arrangement 502 to the second circuit arrangement 504 to operate the second circuit element 604 (or vice versa).

According to some embodiments, and as is schematically illustrated in FIG. 14, the first circuit arrangement 502 may comprise a second laminated substrate, and the second circuit arrangement 504 may comprise a third laminated substrate separate and distinct from the second laminated substrate. In this example, the integrated wireless power transfer device may be mechanically and electrically coupled to one or more contact elements (e.g. contact pads) provided on a surface of the second laminated substrate, and the integrated wireless power transfer device may be mechanically and electrically coupled to one or more contact elements (e.g., contact pads) provided on a surface of the third laminated substrate (contact elements not specifically illustrated in FIG. 14).

For example, one or more contact pads of the plurality of first contact pads 310 may be mechanically and electrically coupled (directly or indirectly via intervening connection elements such as, e.g., pins, or bond wires) to one or more of the contact elements provided on the surface of the second laminated substrate, and one or more contact pads of the plurality of second contact pads 312 may be mechanically and electrically coupled (directly or indirectly via intervening connection elements such as, e.g., pins, or bond wires) to one or more of the contact elements provided on the surface of the third laminated substrate. According to some embodiments, the integrated wireless power transfer device may be mechanically coupled to one or more contact elements provided on a surface of the second laminated substrate by means of a glued joint, a soldered connection, a welded connection, or a clamp connection. Similarly, the integrated wireless power transfer device may be mechanically coupled to one or more contact elements provided on a surface of the third laminated substrate by means of a glued joint, a soldered connection, a welded connection, or a clamp connection.

An electrical device comprising a first circuit arrangement 502 comprising a second laminated substrate, and a second circuit arrangement 504 comprising a third laminated substrate separate and distinct from the second laminated substrate, however, is only an example. According to further examples (not specifically illustrated) it is alternatively possible that the first circuit arrangement 502 is arranged on and/or integrated in a first section of a fourth laminated substrate, and the second circuit arrangement 504 is arranged on and/or integrated in a second section of the fourth laminated substrate. The first section and the second section of the fourth laminated substrate may be arranged next to each other in a lateral direction. A third section of the fourth laminated substrate may be arranged between the first section and the second section, wherein no electrically conducting elements or structures are arranged in the third section. In this way, galvanic isolation may be ensured between the components electrically coupled to different electrical potentials, even if the first circuit arrangement 502 and the second circuit arrangement 504 are arranged on or integrated in one and the same laminated substrate. In this case, the integrated wireless power transfer device may be mechanically and electrically coupled to one or more contact elements provided on a surface of the fourth laminated substrate. In particular, one or more contact pads of the plurality of first contact pads 310 may be mechanically and electrically coupled to one or more first contact elements of the contact elements provided on the surface of the fourth laminated substrate, and one or more contact pads of the plurality of second contact pads 312 may be mechanically and electrically coupled to one or more second contact elements of the contact elements provided on the surface of the fourth laminated substrate.

Similar to what has been described above with respect to FIG. 14, the integrated wireless power transfer device may be mechanically coupled to one or more first contact elements provided on a surface of the fourth laminated substrate by means of a glued joint, a soldered connection, a welded connection, a diffusion bonded connection, or a clamp connection, and the integrated wireless power transfer device may be mechanically coupled to one or more second contact elements provided on a surface of the fourth laminated substrate by means of a glued joint, a soldered connection, a welded connection, or a clamp connection.

Irrespective of whether the integrated wireless power transfer device is electrically and mechanically coupled to two separate laminated substrates (i.e. second and third laminated substrate), or to a single laminated substrate (i.e. fourth laminated substrate), the first circuit element 602 may be or may comprise a controller, and the second circuit element 604 may be or may comprise a controllable transistor device.

In the embodiments illustrated in FIGS. 3 to 14, the plurality of first contact pads 310 are arranged laterally spaced apart from each other along a first lateral side of the laminated substrate 300, and the plurality of second contact pads 312 are arranged laterally spaced apart from each other along a second lateral side of the laminated substrate 300, wherein the second lateral side is opposite the first lateral side. This, however, is only an example. The plurality of first contact pads 310 and the plurality of second contact pads 312 may generally be arranged along the same or along a different lateral side of the laminated substrate 300. Referring to FIG. 15A, for example, the plurality of first contact pads 310 are arranged along a first lateral side of the laminated substrate 300, and the plurality of second contact pads 312 are arranged along a second lateral side of the laminated substrate 300. In this example, however, the second lateral side extends perpendicular to the first lateral side. FIG. 15B schematically illustrates an arrangement in which the plurality of first contact pads 310 and the plurality of second contact pads 312 extend along the same lateral side of the laminated substrate 300. However, as has been described above, the plurality of first contact pads 310 may be arranged closer to the first transformer winding 110a, than to the third transformer winding, and the plurality of second contact pads 312 may be arranged closer to the third transformer winding 210a than to the first transformer winding 110a, in order to ensure sufficient galvanic isolation. In further embodiments (not specifically illustrated), the contact pads forming the plurality of first contact pads 310 may be distributed along more than only one lateral side of the laminated substrate 300 and/or the contact pads forming the plurality of second contact pads 312 may be distributed along more than only one lateral side of the laminated substrate 300.

A laminated substrate 300 is generally formed from a non-conductive material that provides mechanical support and electrical insulation for any components and conductive traces arranged thereon or integrated therein. Laminated substrates may comprise or consist of a rigid material such as, e.g., fiberglass-reinforced epoxy laminate, Bismaleimide-Triazin, BT, resin, or imide based polymers. The laminated substrate 300 may comprise a core element that is used in a lamination process where further layers are added. The core element may itself comprise or consist of a laminated element. Any other suitable materials are generally possible. Multilayer substrates generally comprise two or more different layers. A laminated substrate 300 comprising contact pads arranged on a bottom surface thereof and forming terminal elements for contacting external connection elements may be referred to as Land Grid Array, LGA, substrate. The integrated wireless power transfer device may be provided in the form of an LGA package. In other implementations, the wireless power transfer device may be provided as a Pin Grid Array (PGA) package or Ball Grid Array (BGA) package, where terminal elements may be provided in the form of pins or balls that are connected to the contact pads provided.

If the integrated wireless power transfer device comprises a first control component 114 and/or a second control component 214 arranged on the top surface of the laminated substrate 300, the respective control component(s) 114, 214 may be electrically coupled to the respective structures of the integrated wireless power transfer device by means of a so-called flip-chip assembly. That is, contact pads of the respective control component(s) 114, 214 may be directly attached to respective contact pads provided on the top surface of the laminated substrate 300. Alternatively, it is also possible that the respective control component(s) 114, 214 are electrically coupled to respective contact pads provided on the top surface of the laminated substrate 300 by means of bonding wires.

In conventional wireless power transfer devices, components belonging to one voltage domain are often arranged comparably close to components belonging to another voltage domain. In such wireless power transfer devices, adequate measures need to be taken in order to provide sufficient galvanic isolation between the different voltage domains. For example, one or more layers of a multi-layer substrate may have to be implemented having a defined minimum thickness, if a lateral distance between the concerned components is too short. Alternatively, a lateral distance between the concerned components needs to be increased. Such measures often result in an increased size (laterally and/or vertically) of a respective substrate. The integrated wireless power transfer device according to the different embodiments described herein can be implemented in a compact way, due to the lateral separation of components arranged in one and the same layer of the laminated substrate 300 and belonging to different voltage domains. The integrated wireless power transfer device according to the embodiments described herein fulfills all requirements with respect to functional isolation and reinforced isolation. Reinforced isolation of operating voltages of up to 10.3 kV in the integrated wireless power transfer device is generally only required in a lateral direction, i.e. between the first transformer winding 110a and the third transformer winding 210a arranged on the first layer, and between the fourth transformer winding 210b and the second transformer winding 110b arranged on the second layer of the laminated substrate 300. This reinforced isolation can be easily achieved by arranging the respective components belonging to different voltage domains at a defined lateral distance from each other.

The present disclosure may further be illustrated by the following examples.

An integrated wireless power transfer device according to a first example comprises a laminated substrate 300 comprising a plurality of layers, a first circuit 100 comprising a first transformer winding 110a and a second transformer winding 110b coupled in series between a first input node IN1 and a second input node IN2, a second circuit 200 galvanically isolated from the first circuit 100 and comprising a third transformer winding 210a and a fourth transformer winding 210b coupled in series between a first output node OUT1 and a second output node OUT2, and a plurality of first contact pads 310 and a plurality of second contact pads 312 formed on a bottom surface of the laminated substrate 300, wherein the first transformer winding 110a is formed on a first layer of the laminated substrate 300, the third transformer winding 210a is formed laterally spaced apart from the first transformer winding 110a on the first layer of the laminated substrate 300, the fourth transformer winding 210b is formed vertically above the first transformer winding 110a on a second layer of the laminated substrate 300, the second transformer winding 110b is formed vertically above the third transformer winding 210a on the second layer of the laminated substrate 300, the first contact pads 310 of the plurality of first contact pads 310 are electrically coupled to the first circuit 100, and the second contact pads 312 of the plurality of second contact pads 312 are electrically coupled to the second circuit 200.

According to a second example that is based on the first example, the first circuit 100 may be configured to wirelessly transmit power to the second circuit 200, and/or to wirelessly receive power from the second circuit 200.

According to a third example that is based on the second example, the first circuit 100 may further comprise a first control component 114 arranged on or integrated in the laminated substrate 300, and the second circuit 200 may further comprise a second control component 214 arranged on or integrated in the laminated substrate 300, wherein the first control component 114 and the second control component 214 are configured to control power transfer between the first circuit 100 and the second circuit 200.

According to a fourth example that is based on any of the first to third example, the first contact pads 310 of the plurality of first contact pads 310 may be arranged laterally spaced apart from each other along a lateral side of the laminated substrate 300, and the second contact pads 312 of the plurality of second contact pads 312 may be arranged laterally spaced apart from each other along the same or along a different lateral side of the laminated substrate 300 as the plurality of first contact pads 310.

According to a fifth example that is based on the fourth example, the laminated substrate 300 may comprise a first lateral side and a second lateral side opposite the first lateral side, wherein the first transformer winding 110a and the fourth transformer winding 210b are arranged closer to the first lateral side of the laminated substrate 300 than to the second lateral side, and the third transformer winding 210a and the second transformer winding 110b are arranged closer to the second lateral side of the laminated substrate 300 than to the first lateral side.

According to a sixth example that is based on the fourth or the fifth example, the integrated wireless power transfer device may further comprise a mold compound 400 covering a top surface of the laminated substrate 300 opposite the bottom surface.

According to a seventh example that is based on any of the fourth to sixth example, at least a third layer of the laminated substrate 300 may be arranged between the second layer with the second and fourth transformer windings 110b, 210b formed thereon and a top surface of the laminated substrate 300 opposite the bottom surface, wherein the second control component 214 is arranged on the top surface of the laminated substrate 300, and the first control component 114 is arranged on the top surface of the laminated substrate 300.

According to an eighth example that is based on the seventh example the laminated substrate 300 may comprise a first lateral side and a second laterals side opposite the first lateral side, wherein the second control component 214 is arranged closer to the first lateral side of the laminated substrate 300 than to the second lateral side, and the first control component 114 is arranged closer to the second lateral side of the laminated substrate 300 than to the first lateral side.

According to a ninth example that is based on the eighth example, the second control component 214 may be at least partly arranged vertically above the fourth transformer winding 210b, and/or the first control component 114 may be at least partly arranged vertically above the second transformer winding 110b.

According to a tenth example that is based on the seventh example, the first control component 114 may be arranged closer to the first lateral side of the laminated substrate 300 than to the second lateral side, and the second control component 214 may be arranged closer to the second lateral side of the laminated substrate 300 than to the first lateral side.

According to an eleventh example that is based on the tenth example, the first control component 114 may be laterally spaced apart from the fourth transformer winding 210b such that a lateral distance d1 between the first control component 114 and the fourth transformer winding 210b is greater than zero, and/or the second control component 214 may be laterally spaced apart from the second transformer winding 110b such that a lateral distance d2 between the second control component 214 and the second transformer winding 110b is greater than zero.

According to a twelfth example that is based on any of the previous examples, the first transformer winding 110a may be wound in a clockwise direction, and the second transformer winding 110b may be wound in a counterclockwise direction, or the first transformer winding 110a may be wound in a counterclockwise direction, and the second transformer winding 110b may be wound in a clockwise direction, and the third transformer winding 210a may be wound in a clockwise direction, and the fourth transformer winding 210b may be wound in a counterclockwise direction, or the third transformer winding 210a may be wound in a counterclockwise direction, and the fourth transformer winding 210b may be wound in a clockwise direction.

According to a thirteenth example that is based on any of the previous examples, the integrated wireless power transfer device may further comprise a first magnetic core 402 comprising one or more layers of magnetic material, and extending vertically through the laminated substrate 300 and through a central area of the fourth transformer winding 210b and a central area of the first transformer winding 110a, and/or a second magnetic core 404 comprising one or more layers of magnetic material, and extending vertically through the laminated substrate 300 and through a central area of the second transformer winding 110b and a central area of the third transformer winding 210a.

According to a fourteenth example that is based on any of the previous examples, the integrated wireless power transfer device may further comprise a first magnetic core 402 comprising one or more layers of magnetic material arranged between the fourth transformer winding 210b and the first transformer winding 110a, one or more layers of magnetic material arranged between the first transformer winding 110a and the bottom surface of the laminated substrate 300, and/or one or more layers of magnetic material arranged between the fourth transformer winding 210b and a top surface of the laminated substrate 300 opposite the bottom surface, and/or a second magnetic core 404 comprising one or more layers of magnetic material arranged between the second transformer winding 110b and the third transformer winding 210a, one or more layers of magnetic material arranged between the third transformer winding 210a and the bottom surface of the laminated substrate 300, and/or one or more layers of magnetic material arranged between the second transformer winding 110b and the top surface of the laminated substrate 300.

According to a fifteenth example that is based on any of the previous examples, the first circuit 100 may be configured to be operated in a first voltage domain, and the second circuit 200 is configured to be operated in a second voltage domain different from the first voltage domain.

According to a sixteenth example, an electrical device comprises the integrated wireless power transfer device of any of the previous examples, a first circuit arrangement 502 including a first circuit element 602, wherein the first circuit arrangement 502 is electrically coupled to one or more of the plurality of first contact pads 310, a second circuit arrangement 504 including a second circuit element 604, wherein the second circuit arrangement 504 is electrically coupled to one or more of the plurality of second contact pads 312, wherein the first circuit arrangement 502 is galvanically isolated from the second circuit arrangement 504, and the integrated wireless power transfer device is configured to transmit power from the first circuit arrangement 502 to the second circuit arrangement 504 to operate the second circuit element 604.

According to a seventeenth example that is based on the sixteenth example, the first circuit arrangement 502 may comprise a second laminated substrate, and the second circuit arrangement 504 may comprises a third laminated substrate separate and distinct from the second laminated substrate.

According to an eighteenth example that is based on the seventeenth example, the integrated wireless power transfer device may be mechanically and electrically coupled to one or more contact elements provided on a surface of the second laminated substrate, and the integrated wireless power transfer device may be mechanically and electrically coupled to one or more contact elements provided on a surface of the third laminated substrate.

According to a nineteenth example that is based on the eighteenth examples, one or more contact pads of the plurality of first contact pads 310 may be mechanically and electrically coupled to one or more of the contact elements provided on the surface of the second laminated substrate, and one or more contact pads of the plurality of second contact pads 312 may be mechanically and electrically coupled to one or more of the contact elements provided on the surface of the third laminated substrate.

According to a twentieth example that is based on the eighteenth or the nineteenth example, the integrated wireless power transfer device may be mechanically coupled to one or more contact elements provided on a surface of the second laminated substrate by means of a glued joint, a soldered connection, a welded connection, or a clamp connection, and the integrated wireless power transfer device may be mechanically coupled to one or more contact elements provided on a surface of the third laminated substrate by means of a glued joint, a soldered connection, a welded connection, or a clamp connection.

According to a twenty-first example that is based on the sixteenth example, the first circuit arrangement 502 may be arranged on and/or integrated in a first section of a fourth laminated substrate, and the second circuit arrangement 504 may be arranged on and/or integrated in a second section of the fourth laminated substrate.

According to a twenty-second example that is based on the twenty-first example, the integrated wireless power transfer device may be mechanically and electrically coupled to one or more contact elements provided on a surface of the fourth laminated substrate.

According to a twenty-third example that is based on the twenty-second example, one or more contact pads of the plurality of first contact pads 310 may be mechanically and electrically coupled to one or more first contact elements of the contact elements provided on the surface of the fourth laminated substrate, and one or more contact pads of the plurality of second contact pads 312 may be mechanically and electrically coupled to one or more second contact elements of the contact elements provided on the surface of the fourth laminated substrate.

According to a twenty-fourth example that is based on the twenty-second or the twenty-third example, the integrated wireless power transfer device may be mechanically coupled to one or more first contact elements provided on a surface of the fourth laminated substrate by means of a glued joint, a soldered connection, a welded connection, or a clamp connection, and the integrated wireless power transfer device may be mechanically coupled to one or more second contact elements provided on a surface of the fourth laminated substrate by means of a glued joint, a soldered connection, a welded connection, or a clamp connection.

According to a twenty-fifth example that is based on any of the sixteenth to the twenty-fourth example, the first circuit element 602 may be or may comprise a controller, and the second circuit element 604 may be or may comprise a controllable transistor device.

1. An integrated wireless power transfer device comprising:
a laminated substrate comprising a plurality of layers;
a first circuit comprising a first transformer winding and a second transformer winding coupled in series between a first input node and a second input node;
a second circuit galvanically isolated from the first circuit and comprising a third transformer winding and a fourth transformer winding coupled in series between a first output node and a second output node; and
a plurality of first contact pads and a plurality of second contact pads formed on a bottom surface of the laminated substrate, wherein:
the first transformer winding is formed on a first layer of the laminated substrate,
the third transformer winding is formed laterally spaced apart from the first transformer winding on the first layer of the laminated substrate,
the fourth transformer winding is formed vertically above the first transformer winding on a second layer of the laminated substrate,
the second transformer winding is formed vertically above the third transformer winding on the second layer of the laminated substrate,
the first contact pads of the plurality of first contact pads are electrically coupled to the first circuit, and
the second contact pads of the plurality of second contact pads are electrically coupled to the second circuit.

2. The integrated wireless power transfer device of claim 1, wherein the first circuit is configured to at least one of wirelessly transmit power to the second circuit, or wirelessly receive power from the second circuit.

3. The integrated wireless power transfer device of claim 2, wherein:
the first circuit further comprises a first control component arranged on or integrated in the laminated substrate;
the second circuit further comprises a second control component arranged on or integrated in the laminated substrate; and
the first control component and the second control component are configured to control power transfer between the first circuit and the second circuit.

4. The integrated wireless power transfer device of claim 3, wherein:
the first contact pads of the plurality of first contact pads are arranged laterally spaced apart from each other along a lateral side of the laminated substrate; and
the second contact pads of the plurality of second contact pads are arranged laterally spaced apart from each other along the same or along a different lateral side of the laminated substrate as the plurality of first contact pads.

5. The integrated wireless power transfer device of claim 4, wherein:
the laminated substrate comprises a first lateral side and a second laterals side opposite the first lateral side;
the first transformer winding and the fourth transformer winding are arranged closer to the first lateral side of the laminated substrate than to the second lateral side; and
the third transformer winding and the second transformer winding are arranged closer to the second lateral side of the laminated substrate than to the first lateral side.

6. The integrated wireless power transfer device of claim 4, further comprising a mold compound covering a top surface of the laminated substrate opposite the bottom surface.

7. The integrated wireless power transfer device of claim 4, wherein:
at least a third layer of the laminated substrate is arranged between the second layer with the second and fourth transformer windings formed thereon and a top surface of the laminated substrate opposite the bottom surface;
the second control component is arranged on the top surface of the laminated substrate; and
the first control component is arranged on the top surface of the laminated substrate.

8. The integrated wireless power transfer device of claim 7, wherein:
the laminated substrate comprises a first lateral side and a second laterals side opposite the first lateral side;
the second control component is arranged closer to the first lateral side of the laminated substrate than to the second lateral side; and
the first control component is arranged closer to the second lateral side of the laminated substrate than to the first lateral side.

9. The integrated wireless power transfer device of claim 8, wherein at least one of:
the second control component is at least partly arranged vertically above the fourth transformer winding; or
the first control component is at least partly arranged vertically above the second transformer winding.

10. The integrated wireless power transfer device of claim 7, wherein:
the laminated substrate comprises a first lateral side and a second laterals side opposite the first lateral side;
the first control component is arranged closer to the first lateral side of the laminated substrate than to the second lateral side; and
the second control component is arranged closer to the second lateral side of the laminated substrate than to the first lateral side.

11. The integrated wireless power transfer device of claim 10, wherein at least one of:
the first control component is laterally spaced apart from the fourth transformer winding such that a lateral distance between the first control component and the fourth transformer winding is greater than zero; or
the second control component is laterally spaced apart from the second transformer winding such that a lateral distance between the second control component and the second transformer winding is greater than zero.

12. The integrated wireless power transfer device of claim 1, wherein:
at least one of:
the first transformer winding is wound in a clockwise direction, and the second transformer winding is wound in a counterclockwise direction; or
the first transformer winding is wound in a counterclockwise direction, and the second transformer winding is wound in a clockwise direction; and
at least one of:
the third transformer winding is wound in a clockwise direction, and the fourth transformer winding is wound in a counterclockwise direction; or
the third transformer winding is wound in a counterclockwise direction, and the fourth transformer winding is wound in a clockwise direction.

13. The integrated wireless power transfer device of claim 1, further comprising at least one of:
a first magnetic core comprising one or more layers of magnetic material, and extending vertically through the laminated substrate and through a central area of the fourth transformer winding and a central area of the first transformer winding, or
a second magnetic core, comprising one or more layers of magnetic material, and extending vertically through the laminated substrate and through a central area of the second transformer winding and a central area of the third transformer winding.

14. The integrated wireless power transfer device of claim 1, further comprising at least one of:
a first magnetic core comprising at least one of one or more layers of magnetic material arranged between the fourth transformer winding and the first transformer winding, one or more layers of magnetic material arranged between the first transformer winding and the bottom surface of the laminated substrate, or one or more layers of magnetic material arranged between the fourth transformer winding and a top surface of the laminated substrate opposite the bottom surface, or
a second magnetic core comprising at least one of one or more layers of magnetic material arranged between the second transformer winding and the third transformer winding, one or more layers of magnetic material arranged between the third transformer winding and the bottom surface of the laminated substrate, or one or more layers of magnetic material arranged between the second transformer winding and the top surface of the laminated substrate.

15. The integrated wireless power transfer device of claim 1, wherein:
the first circuit is configured to be operated in a first voltage domain; and
the second circuit is configured to be operated in a second voltage domain different from the first voltage domain.

16. An electrical device, comprising:
the integrated wireless power transfer device of claim 1;
a first circuit arrangement including a first circuit element, wherein the first circuit arrangement is electrically coupled to one or more of the plurality of first contact pads;
a second circuit arrangement including a second circuit element, wherein the second circuit arrangement is electrically coupled to one or more of the plurality of second contact pads, wherein
the first circuit arrangement is galvanically isolated from the second circuit arrangement, and
the integrated wireless power transfer device is configured to transmit power from the first circuit arrangement to the second circuit arrangement to operate the second circuit element.

17. The electrical device of claim 16, wherein:
the first circuit arrangement comprises a second laminated substrate; and
the second circuit arrangement comprises a third laminated substrate separate and distinct from the second laminated substrate.

18. The electrical device of claim 17, wherein:
the integrated wireless power transfer device is mechanically and electrically coupled to one or more contact elements provided on a surface of the second laminated substrate; and
the integrated wireless power transfer device is mechanically and electrically coupled to one or more contact elements provided on a surface of the third laminated substrate.

19. An integrated wireless power transfer device comprising:
a laminated substrate comprising a plurality of layers;
a first circuit comprising a first transformer winding and a second transformer winding;
a second circuit galvanically isolated from the first circuit and comprising a third transformer winding and a fourth transformer winding; and
a plurality of first contact pads and a plurality of second contact pads formed on a bottom surface of the laminated substrate, wherein:
the first transformer winding is formed on a first layer of the laminated substrate,
the third transformer winding is formed on the first layer of the laminated substrate,
the fourth transformer winding is formed on a second layer of the laminated substrate,
the second transformer winding is formed on the second layer of the laminated substrate,
the first contact pads of the plurality of first contact pads are electrically coupled to the first circuit, and
the second contact pads of the plurality of second contact pads are electrically coupled to the second circuit.

20. An integrated wireless power transfer device comprising:
a first circuit comprising a first transformer winding and a second transformer winding;
a second circuit comprising a third transformer winding and a fourth transformer winding; and
a plurality of first contact pads and a plurality of second contact pads formed on a surface of a laminated substrate comprising a plurality of layers, wherein:
the first transformer winding is formed on a first layer of the laminated substrate,
the third transformer winding is formed on the first layer of the laminated substrate,
the fourth transformer winding is formed on a second layer of the laminated substrate,
the second transformer winding is formed on the second layer of the laminated substrate,
the first contact pads of the plurality of first contact pads are electrically coupled to the first circuit, and
the second contact pads of the plurality of second contact pads are electrically coupled to the second circuit.
